(19) United States
(12) Patent Application Publication
(10) Pub. No.: US 2007/0146908 A1
(43) Pub. Date: Jun. 28, 2007

(54) Focal length compensation structure for a lens assembly

(75) Inventor: Min-Che Li, Taichung City (TW)

Correspondence Address: CHARLES E. BAXLEY, ESQ., 90 JOHN STREET, THIRD FLOOR, NEW YORK, NY, 10038, US

(73) Assignee: Largan Precision Co., Ltd.

(21) Appl. No.: 11/317,444

(22) Filed: Dec. 24, 2005

(51) Int. Cl. G02B 7/02

(52) U.S. Cl. 359/820

(57) ABSTRACT

A focal length compensation structure for a lens assembly is used in a portable electronic product having an image taking lens assembly. The lens assembly comprises mounting seat, lens tube and expandable and shrinkable member, the expandable and shrinkable member is disposed between the portable electronic product and the mounting seat, between the mounting seat and the annular connecting portion of the lens tube, and/or between lenses of the lens array. The focal length of the lens array of the lens assembly will change with the outside temperature changes, plus the expansion of the mounting seat and the lens tube, the actual variation of the focal length of the lens assembly. Expansion and shrinkage can be calculated precisely to compensate the distance between the focus of the imaging focal length of the lens array and the image plane, enabling the imaging focal length to be dropped on the image plane precisely, thus forming a clear image.

### BACKGROUND OF THE INVENTION

1. Field of the Invention

The present invention relates to an image taking device, and more particularly to a focal length compensation structure for a lens assembly, the expansion and shrinkage of the expandable and shrinkable member can enable the focus of the imaging focal length of the lens assembly to be projected precisely onto the image plane, thus obtaining a clear image.

2. Description of the Prior Art

With the constant renewal of science and technology, portable electronic products are also changing fast, such as PDA (personal digital assistant), mobile phone. The portable electronic products, for example, the portable electronic products no longer only have a single use, for example, the PDA and mobile phone are equipped with image pickup device, enabling the electronic products to have photo taking and video taking functions, thus enhancing the competitive power of the electronic products.

Lens assembly is one of the principle elements of the image taking device and comprises mounting seat, lens tube and lens array. Since the mounting seat, the lens tube and the lens array are miniaturized, the requirement on machining and fitting tolerances of the image taking device is comparatively strict, such that the focal length of the lens array can be projected on the image plane precisely. When shooting images, image will be projected onto the image plane after passing through the lens array, enabling the image plane to obtain a clear image.

However, in application, the image taking lens assembly still has the problem of fuzzy image, regarding this defect, please refer to the following descriptions: when assembling the image taking lens assembly, the assembly personnel will test if the focal length of the lens array is projected precisely on the image plane in order to make sure that the products are qualified before delivery. Since the products are sold all over the world, and the temperature difference between different parts of the world is large, let alone, in the same place, there is a temperature difference between morning and night. Usually the fitting position of the respective components will also be affected when the temperature difference changes the size of the respective components of the lens assembly, especially the lens assembly is a miniaturized lens assembly. The focal length will not be projected onto the image plane, causing fuzzy image, provided that the temperature difference is great enough to make the focal length deviate 0.1 mm from the image plane,

The present invention has arisen to mitigate and/or obviate the afore-described disadvantages.

### SUMMARY OF THE INVENTION

The primary objective of the present invention is to provide a lens assembly whose focal length can be projected onto the image plane precisely and form a clear image, even when the outside temperature changes.

A focal length compensation for a lens assembly in accordance with the present invention is used in a portable electronic product having an image taking lens assembly. The lens assembly comprises mounting seat, lens tube and expandable and shrinkable member, the expandable and shrinkable member is disposed in 1-3 of the following spaces: between the portable electronic product and the mounting seat, between the mounting seat and the annular connecting portion of the lens tube, and between lenses of the lens array. By such arrangements, the focal length of the lens array of the lens assembly will change with the outside temperature changes, plus the expansion of the mounting seat and the lens tube, the actual variation of the focal length of the lens assembly. Expansion and shrinkage can be calculated precisely to compensate the distance between the focus of the imaging focal length of the lens array and the image plane, enabling the imaging focal length to be dropped on the image plane precisely, forming a clear image.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 shows a portable electronic product having a focal length compensation structure in accordance with the present invention;

FIG. 2 is an illustrative view of showing a focal length compensation structure for a lens assembly in accordance with a first preferred embodiment of the present invention;

FIG. 3 is an illustrative view of showing a focal length compensation structure for a lens assembly in accordance with a second preferred embodiment of the present invention; and

FIG. 4 is an illustrative view of showing the expansion of the expandable and shrinkable member in accordance with the second preferred embodiment of the present invention.

### DETAILED DESCRIPTION OF THE PREFERRED EMBODIMENTS

The foregoing, and additional objects, features and advantages of the present invention will be best understood from the following detailed description of two preferred embodiments thereof, taken in conjunction with the accompanying drawings.

### A FIRST EMBODIMENT

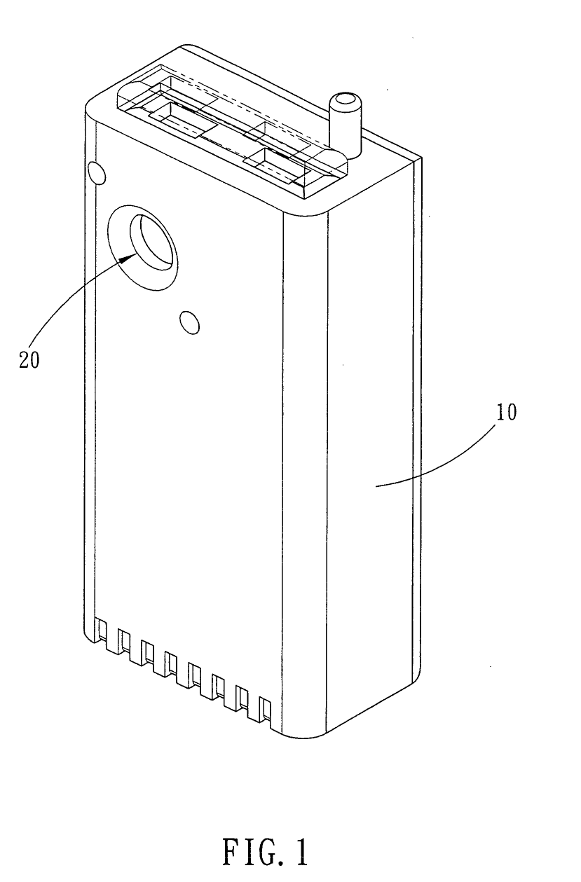

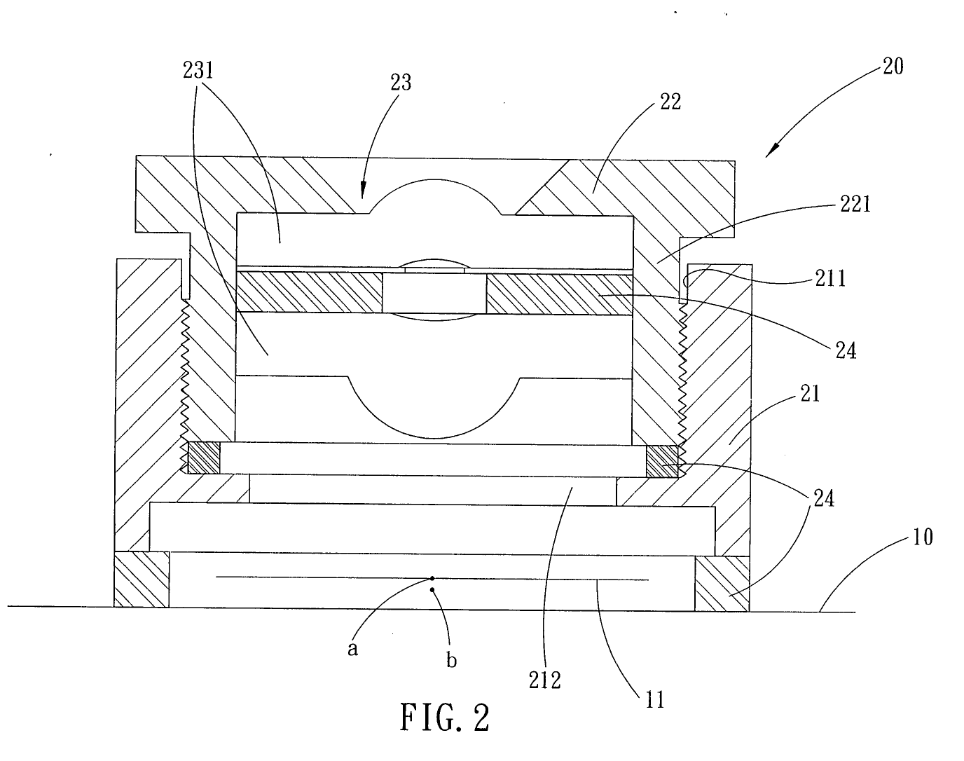

Referring firstly to FIG. 1, let's take the example of a mobile phone that is a portable electronic product 10 having an image taking lens assembly, in which, length focal compensation structure is installed in the lens assembly 20 of the electronic product 10. The lens assembly 20 comprises a mounting seat 21, a lens tube 22, a lens array 23 and three expandable and shrinkable members 24, with reference to FIG. 2.

The mounting seat 21 is located over an image plane 11 of the electronic product 10 and has a connecting groove 211. In the wall of the connecting groove 211 is formed with threaded structure, and in the center of the bottom of the connecting groove 211 is formed a through passage 212.

The lens tube 22 has an annular connecting portion 221 whose outer periphery being formed with threaded structure, and the annular connecting portion 221 of the lens tube 22 is screwed in the connecting groove 211 of the mounting seat 21.

The lens array 23 includes two lenses 231 that are arranged in parallel in the lens tube 22 and located over the through passage 212 of the mounting seat 21, and the focus a of the imaging focal length of the lens array 23 is located on the image plane 11.

The expandable and shrinkable members 24 are linearly expandable and shrinkable with temperature changes of the mounting seat 21 and the lens tube 22, and the expandable and shrinkable members 24 in this embodiment are annular members, for example, that are arranged between the surface of the portable electronic product 10 and the bottom of the mounting seat 21, between the connecting groove 211 of the mounting seat 21 and the bottom of the annular connecting portion 221 of the lens tube 22, and between the lenses 231 of the lens array 23.

For a better understanding of the first preferred embodiment of the present invention, its operation and function, reference should be made to FIG. 2 and the following description.

When outside temperature variation is positive, it will lead to positional deviation of the respective components of the lens assembly 20, causing the focus of the imaging focal length of the lens array 23 to be deviated toward the inside of the image plane 11, so that the focus a of the imaging focal length of the lens array 23 will shifted to position b (at normal temperature, the focus a of the imaging focal length of the lens array 23 is located on the imaging plane).

However, when the foregoing phenomenon occurs, since the expandable and shrinkable members 24 are linearly expandable and shrinkable with temperature changes of the mounting seat 21 and the lens tube 22, the expandable and shrinkable members 24 will expand to a certain extent, and will push to adjust the position between the portable electronic product 10 and the mounting seat 21, between the connecting groove 211 of the mounting seat 21 and the bottom of the annular connecting portion 221 of the lens tube 22, and between the lenses 231 of the lens array 23, and then make the imaging focal length of the lens array 23 return from focus b to point a. The imaging focal length of the lens array 23 will be focused on the image plane 11 again, obtaining a clear image.

### A Second Embodiment

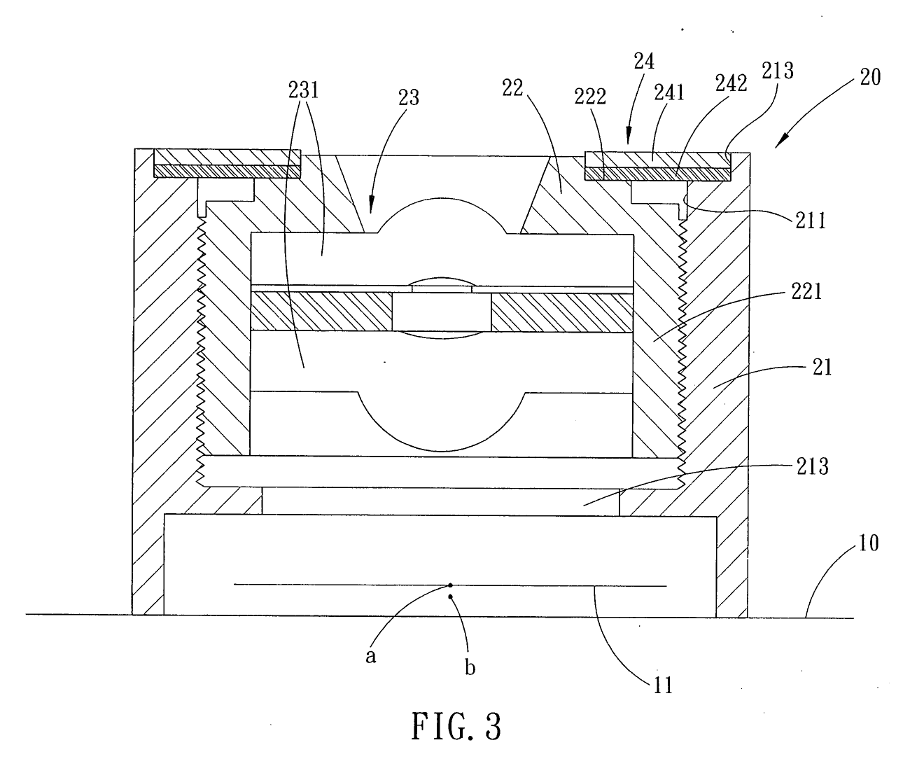

Referring to FIG. 3, in the edge of the connecting groove 211 of the mounting seat 21 are formed two opposite fitting grooves 213, in the top of the lens tube 22 are formed two opposite receiving grooves 222, and the bottom of the fitting groove 213 of the mounting seat 21 and that of the receiving groove 222 of the lens tube 22 are arranged horizontally. At the bottom of the fitting groove 213 of the mounting seat 21 and that of the receiving groove 222 of the lens tube 22 is disposed a double-layer expandable and shrinkable member 24 formed by two sheet members 241, 242. The two sheet members 241 and 242 are made of different materials and have different linear expanding and shrinking capabilities.

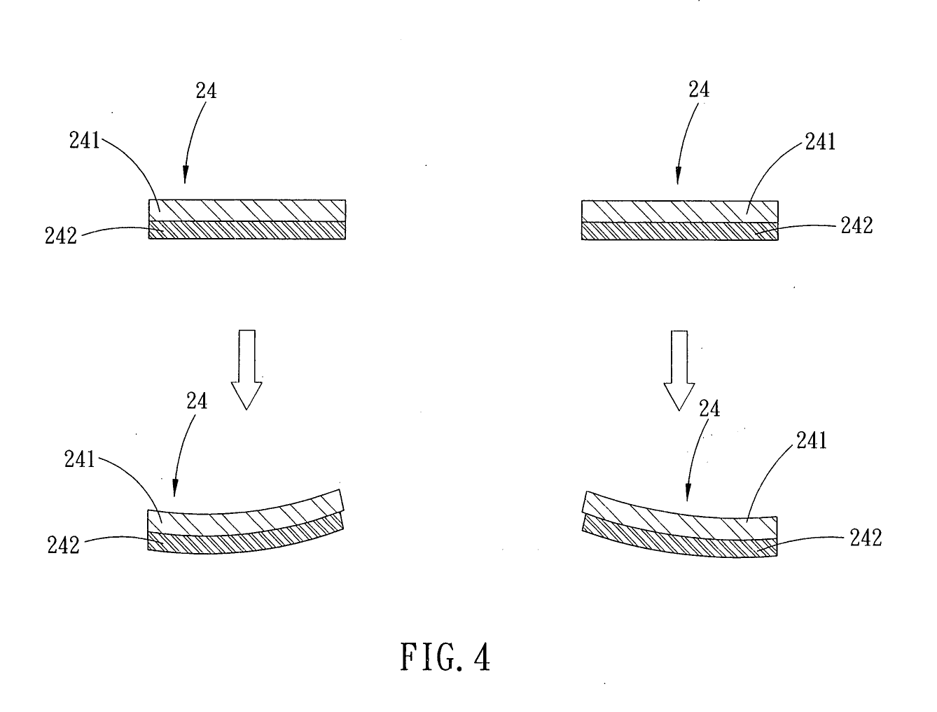

Regarding the operation of the second preferred embodiment, please refer to FIGS. 3 and 4.

When outside temperature variation is positive, it will lead to positional deviation of the respective components of the lens assembly 20, causing the focus of the imaging focal length of the lens array 23 to be deviated toward the inside of the image plane 11, so that the focus a of the imaging focal length of the lens array 23 will shifted to position.

When the foregoing phenomenon occurs, since the expandable and shrinkable member 24 is linearly expandable and shrinkable with temperature changes of the mounting seat 21 and the lens tube 22, the two sheet members 241 and 242 of the expandable and shrinkable member 24 will expand and bend outward from the fitting grooves 213 of the mounting seat 21 toward the receiving groove 222 of the lens tube 22 (namely, both ends of the sheet members 241 and 242 will expand and bend outward toward the center thereof), and meanwhile it will drive the lens tube 22 to the original position inside the mounting seat 21. As a result, the imaging focal length of the lens array 23 will return from focus b to point a and will be projected onto the image plane 11 again, obtaining a clear image.

It will be noted that, in the first and second embodiments, the compensation of the focal length of the lens assembly is described under the condition that the temperature variation is positive. When the temperature variation is negative, the corresponding operation is performed reversely to the aforementioned operation, so further remarks will be omitted. The expandable and shrinkable member can be steel, aluminum, or plastic materials.

While we have shown and described various embodiments in accordance with the present invention, it should be clear to those skilled in the art that further embodiments may be made without departing from the scope of the present invention.

What is claimed is:

1. A focal length compensation structure for a lens assembly used in a portable electronic product having an image taking lens assembly and an image plane, the lens assembly comprising:
a mounting seat;
a lens tube installed on the mounting seat;
a lens array including at least a lens and being disposed in the lens tube, a focus of an imaging focal length of the lens array is located on the image plane of the portable electronic product; and
at least an expandable and shrinkable member disposed in 1-3 of the following spaces: between the portable electronic product and the mounting seat, between the mounting seat and the annular connecting portion of the lens tube, and between lenses of the lens array.

2. The focal length compensation structure for a lens assembly as claimed in claim 1, wherein the mounting seat has a connecting groove, the lens tube has an annular connecting portion that is to be screwed in the connecting groove of the mounting seat, the expandable and shrinkable member is disposed between a bottom of the connecting groove of the mounting seat and that of the annular connecting portion of the lens tube.

3. The focal length compensation structure for a lens assembly as claimed in claim 1, wherein at least a fitting groove is formed in an edge of the connecting groove of the mounting seat, in a top of the lens tube is formed at least receiving groove, bottom of the fitting groove of the mounting seat and that of the receiving groove of the lens tube are arranged horizontally, at the bottom of the fitting groove of the mounting seat and that of the receiving groove of the lens tube is disposed an expandable and shrinkable member.

4. The focal length compensation structure for a lens assembly as claimed in claim 1, wherein the expandable and shrinkable member is formed by two sheet members that are made of different materials and have different linear expanding and shrinking capabilities.
